(19) United States
(12) Patent Application Publication
(10) Pub. No.: US 2009/0297294 A1
(43) Pub. Date: Dec. 3, 2009

(54) QUICK FASTENING NUT

(75) Inventors: Chun-Hung LI, Taichung (TW); Wei-Mien HSU, Taichung (TW); Yong-Jun WU, Shenzhen City (CN)

Correspondence Address: BROWDY AND NEIMARK, P.L.L.C.;624 NINTH STREET, NW, SUITE 300, WASHINGTON, DC, 20001-5303, US

(73) Assignee: GLOBE UNION INDUSTRIAL CORP., TAICHUNG (TW)

(21) Appl. No.: 12/131,602

(22) Filed: Jun. 2, 2008

(51) Int. Cl. F16B 37/08

(52) U.S. Cl. 411/433

(57) ABSTRACT

A quick fastening nut includes a first ring member and a second ring member. The first ring member has a bore at a center thereof and fastening portions around the bore. Each of the fastening portions has a threaded section at an inner side thereof. The second ring member has a bore at a center thereof and a plurality of stop portions, each of which has a stop face on a distal end thereof. The fastening portions of the first ring member is inserted into the bore of the second ring member that the second ring member may be moved along the fastening portions of the first ring member, and the second ring member will bend the fastening portions inwards when the second ring member is moved toward distal ends of the fastening portions.

### BACKGROUND OF THE INVENTION

1. Field of the Invention

The present invention relates generally to a fastener and, more particularly, to a quick fastening nut.

2. Description of the Related Art

Typically, to secure a product having a thread to an object, a nut usually is involved. For example, to mount a faucet on a table, a tube having a thread on a back of the faucet is inserted into a bore of the table, and a nut is screwed onto the tube from a back of the table to secure the faucet on the table. It takes a lot of time in screwing the nut when secure the faucet. For some conditions, such as the thread is long or it doesn't have enough space to screw the nut, it will take longer time to screw the nut.

### SUMMARY OF THE INVENTION

The primary objective of the present invention is to provide a quick fastening nut which has a quick and simple way to fasten and release the nut, furthermore, it provides a firm connection.

To achieve the objective of the present invention, a quick fastening nut includes a first ring member and a second ring member. The first ring member has a bore at a center thereof and fastening portions around the bore. Each of the fastening portions has a threaded section at an inner side thereof. The second ring member has a bore at a center thereof and a plurality of stop portions, each of which has a stop face on a distal end thereof. The fastening portions of the first ring member is inserted into the bore of the second ring member that the second ring member may be moved along the fastening portions of the first ring member, and the second ring member will bend the fastening portions inwards when the second ring member is moved toward distal ends of the fastening portions.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a sectional view of the first preferred embodiment of the present invention;

FIG. 4 and FIG. 5 are sketch diagrams of the first preferred embodiment of the present invention, showing how to fasten the nut;

FIG. 6 is an exploded view of a second preferred embodiment of the present invention;

FIG. 7 is a perspective view of the second preferred embodiment of the present invention;

FIG. 8 is an exploded view of a third preferred embodiment of the present invention; and

FIG. 9 is a sectional view of the third preferred embodiment of the present invention.

### DETAILED DESCRIPTION OF THE INVENTION

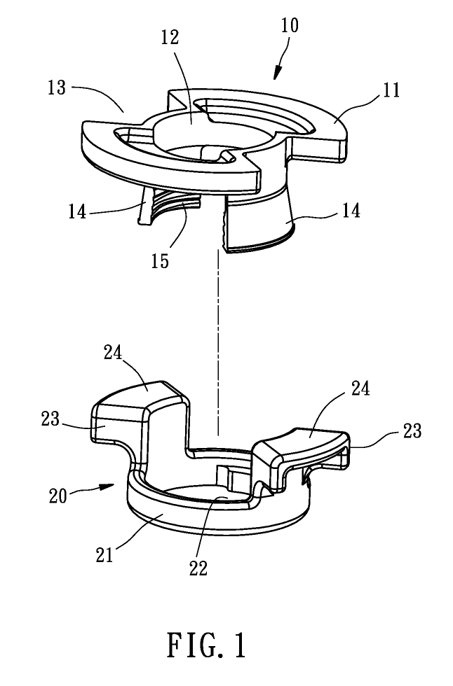

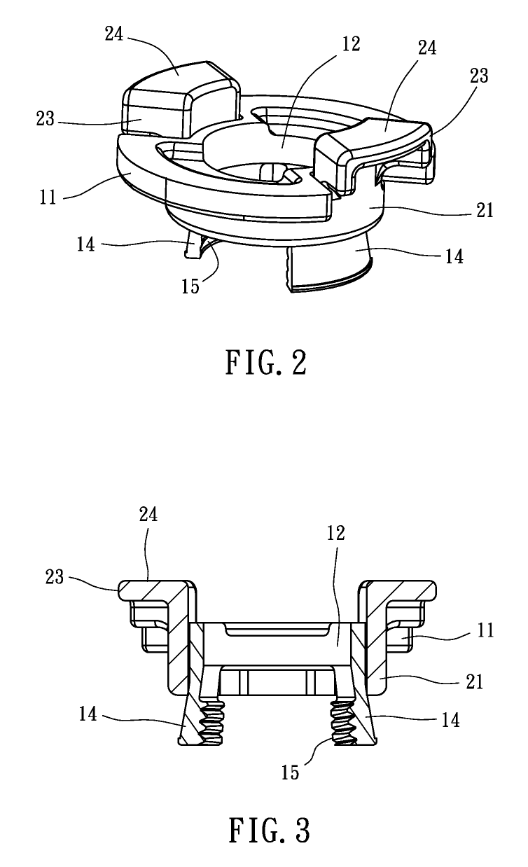

As shown in FIGS. 1 to 3, a quick fastening nut of the first preferred embodiment of the present invention includes:

A first ring member 10 includes a ring 11 having a bore 12 at a center thereof and two gaps 13 extended inwards from an edge thereof. The first ring member 10 further includes two fastening portions 14 projected from a side of the ring 11 between the bore 12 and the gaps 13 respectively. Each of the fastening portions 14 has a thickness gradually greater from a proximal end to a distal end that a distance between outer sides of the distal ends of the fastening portions 14 is greater than that of between outer sides of the proximal ends of the fastening portions 14. Each of the fastening portions 14 has a threaded section 15 on an inner side thereof, and a length of the threaded section 15 is equal to or less than ⅔ of a length of the fastening portion 14.

A second ring member 20 includes a ring 21 having a bore 22 at a center thereof. A diameter of the bore 22 of the ring 21 of the second ring member 20 is greater than that of the bore 12 of the ring 11 of the first ring member 10. The second ring member 20 further includes two stop portions 23 projected from a side of the ring 22, each of which has a stop face 24 at a distal end thereof. Basically, a number of the gaps 13 of the first ring member 10 is identical to the stop portions 23 of the second ring member 20. The first ring member 10 has the fastening portions 14 inserted into the bore 22 of the second ring member 20, and the stop portions 23 of the second ring member 20 extended through the gaps 13 of the first ring member 10 that the first ring member 10 and the second ring member 20 are connected together. In this condition, the second ring member 20 cannot rotate relatively because of the engagement of the gaps 13 and the stop portions 23, but is still allowed to move axially relative to the first ring member 10. In other words, the gaps 13 form a restrict portion to allow the first ring member 10 moving relative to the second ring member 20 but rotating.

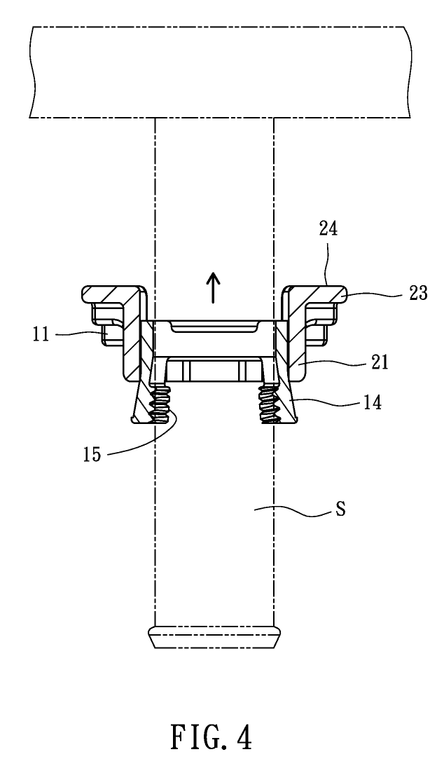

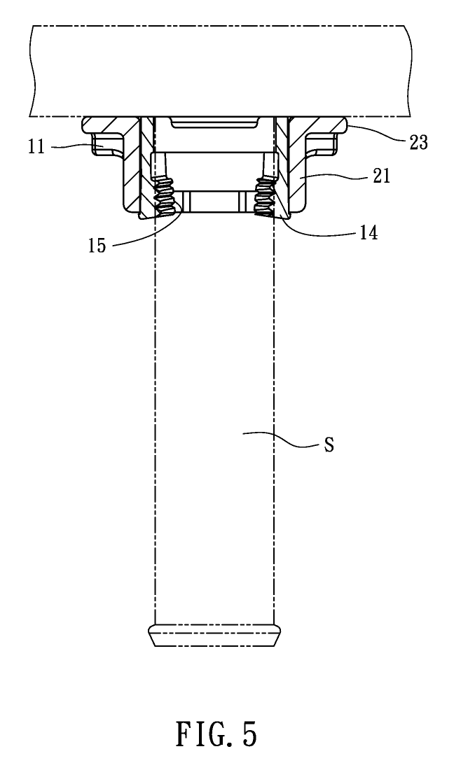

To fasten a faucet having a threaded tube S by the quick fastening nut of the first preferred embodiment of the present invention, as shown in FIG. 4, user fits the bore 12 of the first ring member 10 to the threaded tube S. In this step, the second ring member 20 is at the proximal ends of the fastening portions 14 so the quick fastening nut of the present invention is free to move along the threaded tube S. When the quick fastening nut of the present invention arrives a proximal end of the threaded tube S, as shown in FIG. 5, the stop face 24 of the second ring member 20 will touch a bottom of a table first that the second ring member 20 is stopped and the first ring member 10 is still free to move. Next, user may move the first ring member 10 continuously that will cause the ring 21 of the second ring member 20 moving toward the distal ends of the fastening portions 14 and bending the fastening portions 14 inwards. This will engage the threaded sections 15 of the fastening portions 14 with the threaded tube S. As the harder the first ring member 10 is pushed, the tighter the engagement of the fastening portions 14 and the threaded tube S is. To secure the faucet more tightly, user may turn the quick fastening nut of the present invention, like screwing a nut.

To release the quick fastening nut of the present invention, user turns the first ring member 10 reversely to move the first ring member 10 away from the table and let the second ring member 20 may be moved to the distal ends of the fastening portions 14 that will disengage the fastening portions 14 with the threaded tube S and draw the quick fastening nut of the present invention out of the threaded tube S quickly.

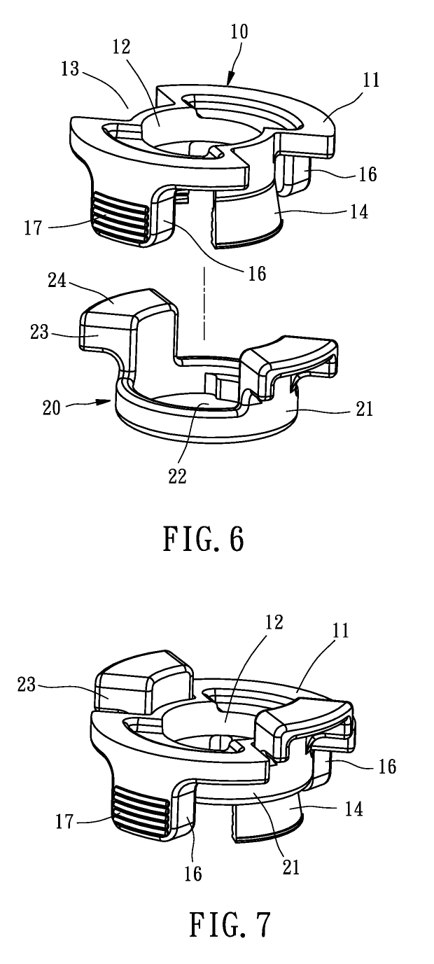

As shown in FIG. 6 and FIG. 7, a quick fastening nut of the second preferred embodiment of the present invention, which is similar to the first preferred embodiment, includes a first ring member 10 and a second ring member 20. The different part is that the first ring member 10 further has two protrusions 16 projected from a ring 11. The protrusions 16 and fastening portions 14 are on the same side of the ring 11. Each of the protrusions 16 has textures 17 thereon. The function of the protrusions 16 is that user may hold the protrusions 16 to turn the quick fastening nut of the second preferred embodiment of the present invention.

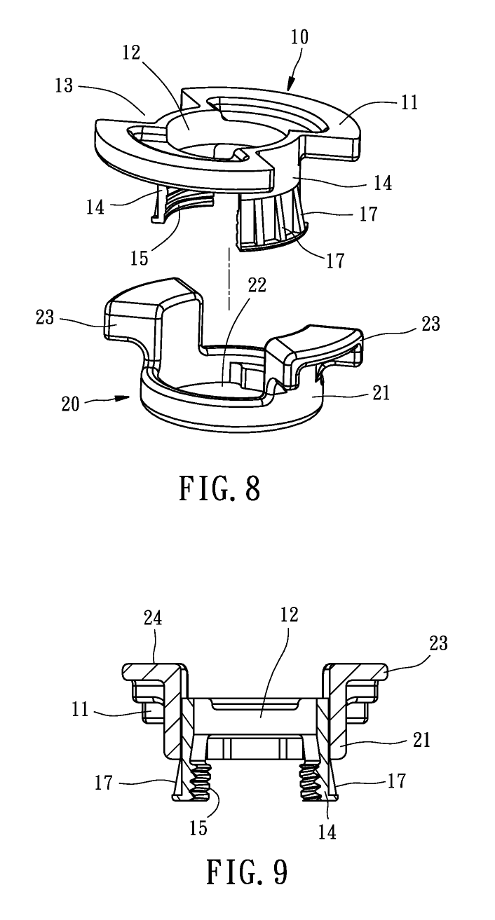

FIG. 8 and FIG. 9 shows a quick fastening nut of the second preferred embodiment of the present invention, which is similar to the first preferred embodiment, including a first ring member 10 and a second ring member 20. The first ring member 10 has two fastening portions 14, each of which has a constant thickness and a plurality of ribs 17 on an outer side thereof. Theses ribs 17, as shown in FIG. 9, have triangular shapes that heights thereof are gradually greater from an end proximal to the proximal ends of the fastening portions 14 to the other ends proximal to the distal ends of the fastening portions 14. The operation of the quick fastening nut of the second preferred embodiment is as same as the first preferred embodiment that the ribs 17 is functional to bend the fastening portions 14 when the second ring member 20 is move toward the distal ends of the fastening portions 14.

Although the particular embodiments of the invention has been described in detail for purposes of illustration, various modifications and enhancements may be made without departing from the spirit and scope of the invention. Accordingly, the invention is not to be limited except as by the appended claims.

What is claimed is:

1. A quick fastening nut, comprising:
a first ring member having a ring, which has a bore at a center thereof, and a plurality of fastening portions projected from a side of the ring and around the bore, wherein each of the fastening portions has a threaded section at an inner side thereof; and
a second ring member having a ring, which has a bore at a center thereof, and a plurality of stop portions projected from a side of the ring, wherein the bore of the ring of the second ring member is greater than that of the bore of the ring of the first ring member, and each of the stop portions has a stop face on a distal end thereof;
wherein the fastening portions of the first ring member is inserted into the bore of the second ring member that the second ring member may be moved along the fastening portions of the first ring member, and the second ring member will bend the fastening portions inwards when the second ring member is moved toward distal ends of the fastening portions.

2. The quick fastening nut as claimed in claim 1, wherein each of the fastening portions is gradually thicker from a proximal end to the distal end that a diameter of the distal ends of the fastening portions is greater than that of the proximal ends of the fastening portions.

3. The quick fastening nut as claimed in claim 1, wherein the ring of the first ring member has a plurality of gaps that the stop portions of the second ring member are extended through the gaps respectively.

4. The quick fastening nut as claimed in claim 3, wherein the gaps form restrict portions that the second ring member will be turned along with the first ring member when the first ring member is turned.

5. The quick fastening nut as claimed in claim 4, wherein the fastening portions have ribs thereon, each of which is gradually higher from an end proximal to the proximal end of the fastening portion to an end proximal to the distal end of the fastening portion.

6. The quick fastening nut as claimed in claim 5, wherein the first ring member further has a plurality of protrusion projected from the ring, and the protrusions and the fastening portions are on the same side of the ring.

7. The quick fastening nut as claimed in claim 6, wherein the protrusions have textures thereon.

8. The quick fastening nut as claimed in claim 1, wherein a length of the threaded section is identical to or less than ⅔ of a length of the fastening portion.
